(19) United States
(12) Patent Application Publication
(10) Pub. No.: US 2024/0171644 A1
(43) Pub. Date: May 23, 2024

(54) NETWORK APPARATUS, METHOD, AND NON-TRANSITORY COMPUTER-READABLE MEDIUM

(71) Applicant: NEC Corportion, Minato-ku, Tokyo (JP)

(72) Inventor: Yoshihiko HOSHINO, Tokyo (JP)

(73) Assignee: NEC Corportion, Minato-ku, Tokyo (JP)

(21) Appl. No.: 18/282,010

(22) PCT Filed: Mar. 19, 2021
(86) PCT No.: PCT/JP2021/011385

§ 371 Date: Sep. 14, 2023

(51) Int. Cl. H04L 67/147; H04L 69/08; H04L 69/18

(52) U.S. Cl. CPC H04L 67/147; H04L 69/08; H04L 69/18

(57) ABSTRACT

A network apparatus according to the present disclosure includes a memory (902) and at least one processor (901) coupled to the memory (902). The at least one processor has a function of converting a Diameter protocol compatible message to an SBI protocol compatible message, and a function of converting an SBI protocol compatible message to a Diameter protocol compatible message.

### TECHNICAL FIELD

The present disclosure relates to a network apparatus, a method and a non-transitory computer-readable medium.

### BACKGROUND ART

In recent years, examination of a wireless communication system compatible with both 4G (4th Generation) and 5G (5th Generation) has been prompted.

For example, Patent Literature 1 discloses a wireless communication system configured by a wireless communication system according to 4G and a wireless communication system according to 5G.

### CITATION LIST

### Patent Literature

Patent Literature 1: International Patent Publication No. WO2018/207775

### SUMMARY OF INVENTION

### Technical Problem

Incidentally, in a 5GC (5th Generation Core network), it is defined that an SMF (Session Management Function)+PGW-C(Packet data network Gateway-Control plane) is combined with a PCF (Policy Control Function), and the SMF+PGW-C can be connected with the PCF by an SBI (Service Based Interface).

However, a Diameter protocol used by the SMF+PGW-C for connection with a PCRF (Policy and Charging Rule Function) in 4G is not defined as a standard. Therefore, the SMF+PGW-C could not be connected with the PCRF. As a result, even when UE (User Equipment) was located in a 4G area, there was a problem that a 4G service policy could not be applied to the UE.

In addition, in the 5GC, it was assumed as general or de facto matters that a Gi-LAN (Local Area Network) apparatus is connected with the PCRF and flexible policy control is executed.

However, as described above, since the Diameter protocol is not defined as the standard, the PCF could not be connected with the Gi-LAN apparatus. As a result, even when the UE was located in a 5G area, there was a problem that a 5G service policy could not be applied to the UE.

Therefore, an object of the present disclosure is to solve the problem described above and to provide a network apparatus, a method, and a non-transitory computer-readable medium capable of applying a 4G service policy to UE located in a 4G area and applying a 5G service policy to UE located in a 5G area.

### Solution to Problem

A network apparatus according to one aspect includes:
a memory; and
at least one processor coupled to the memory,
and the at least one processor includes
a function of converting a Diameter protocol compatible message to an SBI protocol compatible message, and a function of converting the SBI protocol compatible message to the Diameter protocol compatible message.

A method according to one aspect is
the method executed by a network apparatus, and includes:
a step of converting a Diameter protocol compatible message to an SBI protocol compatible message; and
a step of converting the SBI protocol compatible message to the Diameter protocol compatible message.

A non-transitory computer-readable medium according to one aspect stores a program for making a computer execute:
a procedure of converting a Diameter protocol compatible message to an SBI protocol compatible message; and
a procedure of converting the SBI protocol compatible message to the Diameter protocol compatible message.

### Advantageous Effects of Invention

According to the aspects described above, an effect of being capable of providing a network apparatus, a method and a non-transitory computer-readable medium capable of applying a 4G service policy to UE located in a 4G area and applying a 5G service policy to UE located in a 5G area can be obtained.

### BRIEF DESCRIPTION OF DRAWINGS

FIG. 1 is a diagram illustrating an overall configuration example of a wireless communication system according to a first example embodiment;

FIG. 2 is a sequence diagram explaining an operation example when UE located in a 4G area is attached in a wireless communication system according to related art;

FIG. 3 is a sequence diagram explaining an operation example when UE located in a 5G area is attached in the wireless communication system according to related art;

FIG. 4 is a sequence diagram explaining an operation example when UE located in the 4G area is attached in the wireless communication system according to the first example embodiment;

FIG. 5 is a sequence diagram explaining an operation example when UE located in the 5G area is attached in the wireless communication system according to the first example embodiment;

FIG. 6 is a diagram illustrating an overall configuration example of a wireless communication system according to a second example embodiment;

FIG. 7 is a sequence diagram explaining an operation example when UE located in the 4G area is attached in the wireless communication system according to the second example embodiment;

FIG. 8 is a sequence diagram explaining an operation example when UE located in the 5G area is attached in the wireless communication system according to the second example embodiment; and

FIG. 9 is a block diagram illustrating a hardware configuration example of a computer which realizes a network apparatus according to the first and second example embodiments.

### EXAMPLE EMBODIMENTS

Hereinafter, example embodiments of the present disclosure will be explained with reference to the drawings. Note that the description and the drawings below are appropriately omitted and simplified in order to clarify explanation. In addition, in each drawing below, the same signs are attached to the same elements and repetitive explanation is omitted as needed.

### First Example Embodiment

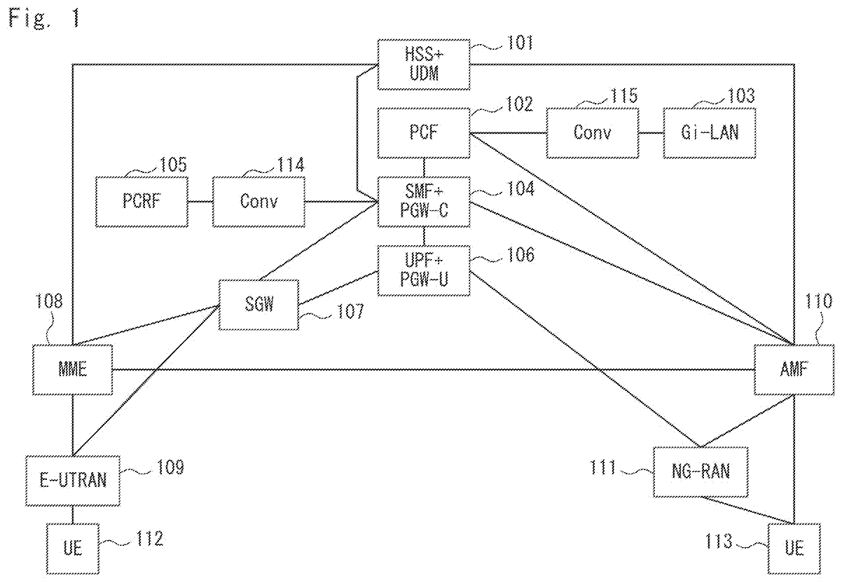

First, with reference to FIG. 1, an overall configuration example of a wireless communication system according to the present first example embodiment will be explained.

As illustrated in FIG. 1, the wireless communication system according to the present first example embodiment is characterized by a point that converters 114 and 115 (written as “Cony” in the figure) which are SBI-Diameter conversion apparatuses are newly introduced. That is, in the present first example embodiment, a network apparatus according to the present disclosure is the converters 114 and 115.

The converters 114 and 115 have a function of converting a Diameter protocol compatible message to an SBI protocol compatible message, and a function of converting an SBI protocol compatible message to a Diameter protocol compatible message.

The wireless communication system according to the present first example embodiment includes the converters 114 and 115 described above, and includes an HSS (Home Subscriber Server)+UDM (Unified Data Management) 101, a PCF 102, a Gi-LAN apparatus 103, an SMF+PGW-C 104, a PCRF 105, an UPF (User Plane Function)+PGW-U (Packet data network Gateway-User plane) 106, an SGW (Serving Gateway) 107, an MME (Mobility Management Entity) 108, an E-UTRAN (Evolved-Universal Terrestrial Radio Access Network) 109, an AMF (Access and Mobility Management Function) 110, an NG-RAN (Next Generation-Radio Access Network) 111, and UE 112 and 113. Note that the SMF+PGW-C 104 is combined with the PCF 102. Therefore, hereinafter, an apparatus for which the SMF+PGW-C 104 and the PCF 102 are combined is appropriately called as an SMF+PGW-C104 combo/PCF102.

Here, the converter 114 is connected to the SMF+PGW-C104 combo/PCF102 and the PCRF 105 or the like.

When an Npcf_SMPolicyControl Request message which is the SBI protocol compatible message is received from the SMF+PGW-C104 combo/PCF102, the converter 114 converts the Npcf_SMPolicyControl Request message to a Credit Control Request message (written as “CC Req.” in the figure) which is the Diameter protocol compatible message. Then, the converter 114 transmits the Credit Control Request message to the PCRF 105.

In addition, when an Ack (Acknowledgement) message which is the Diameter protocol compatible message is received from the PCRF 105, the converter 114 converts the Ack message to an Ack message which is the SBI protocol compatible message. Then, the converter 114 transmits the Ack message to the SMF+PGW-C104 combo/PCF102.

On the other hand, the converter 115 is connected to the SMF+PGW-C104 combo/PCF102 and the Gi-LAN apparatus 103 or the like.

When the Credit Control Request message which is the Diameter protocol compatible message is received from the Gi-LAN apparatus 103, the converter 115 converts the Credit Control Request message to the Npcf_SMPolicyControl Request message which is the SBI protocol compatible message. Then, the converter 115 transmits the Npcf_SMPolicyControl Request message to the SMF+PGW-C104 combo/PCF102.

In addition, when the Ack message which is the SBI protocol compatible message is received from the SMF+PGW-C104 combo/PCF102, the converter 115 converts the Ack message to the Ack message which is the Diameter protocol compatible message. Then, the converter 115 transmits the Ack message to the Gi-LAN apparatus 103.

Hereinafter, before explaining an operation of the wireless communication system according to the present first example embodiment, an operation of the wireless communication system in which the converters 114 and 115 are not introduced, according to the related art of the present first example embodiment, will be explained.

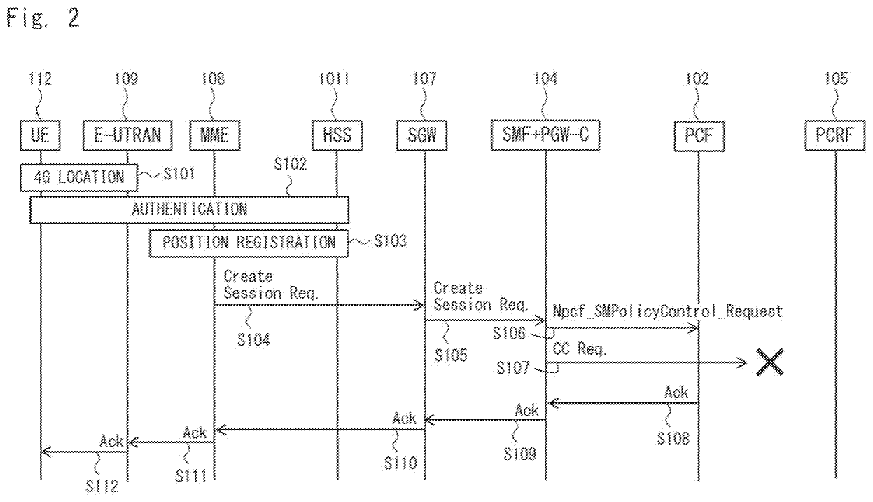

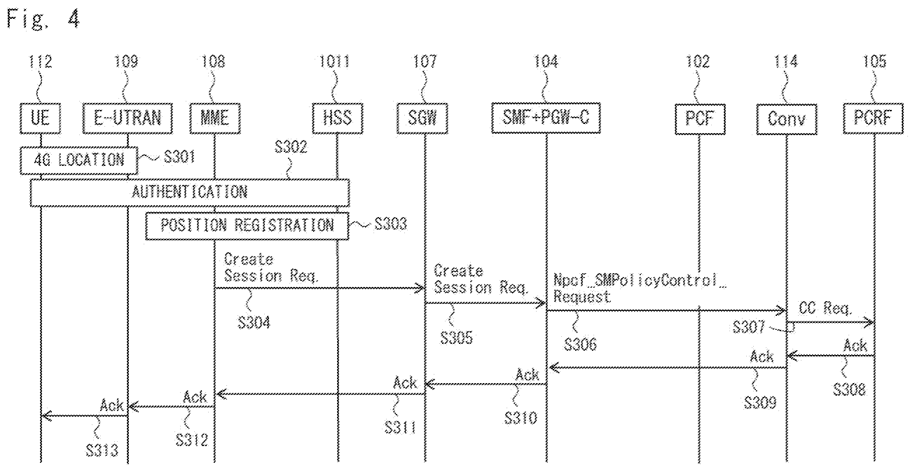

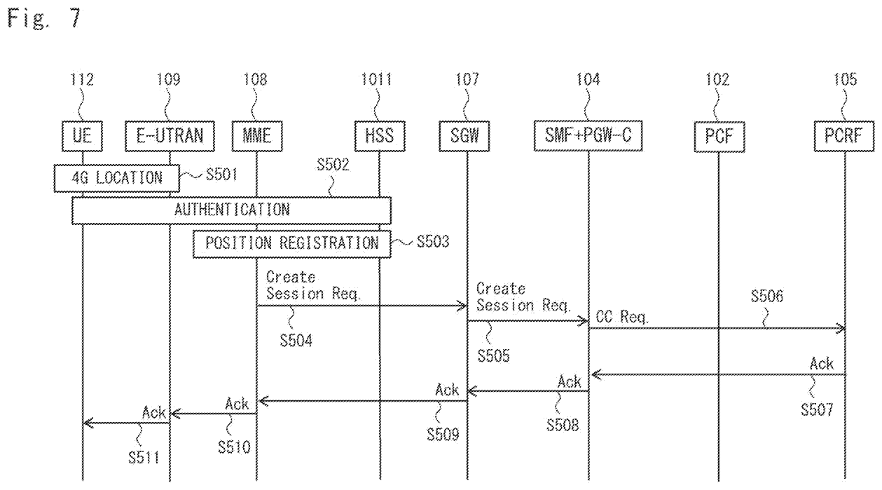

First, with reference to FIG. 2, an operation example when the UE 112 located in a 4G area is attached in the wireless communication system according to the related art will be explained. Note that, in FIG. 2, an HSS 1011 corresponds to a part of an HSS in the HSS+UDM 101 in FIG. 1 (same in FIG. 4 and FIG. 7 to be explained below).

As illustrated in FIG. 2, the UE 112 is located in the 4G area, that is an area of the E-UTRAN 109 (step S101). In this case, the MME 108 authenticates the UE 112 using authentication information registered in the HSS 1011 (step S102), and registers position information of the UE 112 to the HSS 1011 (step S103).

Next, the MME 108 transmits the Create Session Request message to the SGW 107 (step S104), and the SGW 107 transmits the Create Session Request message to the SMF+PGW-C 104 (step S105).

Next, the SMF+PGW-C 104 transmits the Npcf_SMPolicyControl Request message which is the SBI protocol compatible message to the PCF 102 (step S106).

In addition, the SMF+PGW-C 104 should transmit the Credit Control Request message which is the Diameter protocol compatible message to the PCRF 105.

However, the Diameter protocol is not defined as a standard. Therefore, the SMF+PGW-C 104 could not be connected with the PCRF 105 and could not transmit the Credit Control Request message to the PCRF 105 (step S107). Note that, in this case, the Ack message is transmitted from the PCF 102 to the UE 112 via the SMF+PGW-C 104, the SGW 107, the MME 108 and the E-UTRAN 109 (steps S108-S112).

As a result, in the wireless communication system according to the related art, even when the UE 112 was located in the 4G area, there was a problem that a 4G service policy could not be applied from the PCRF 105 to the UE 112.

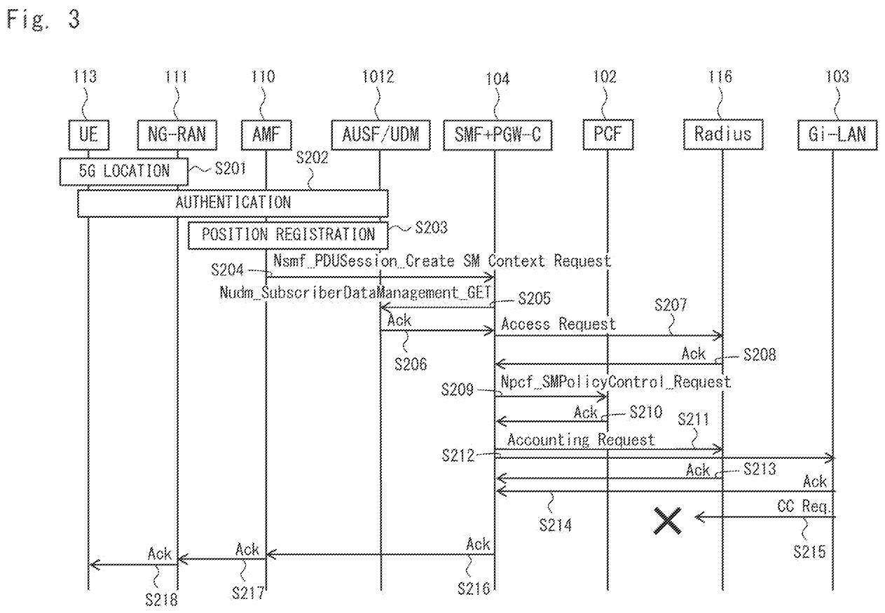

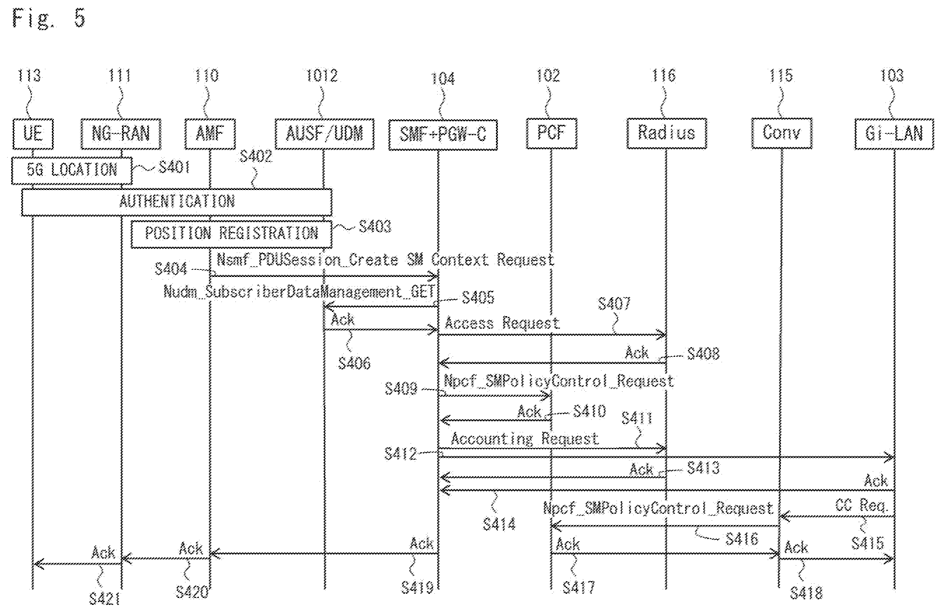

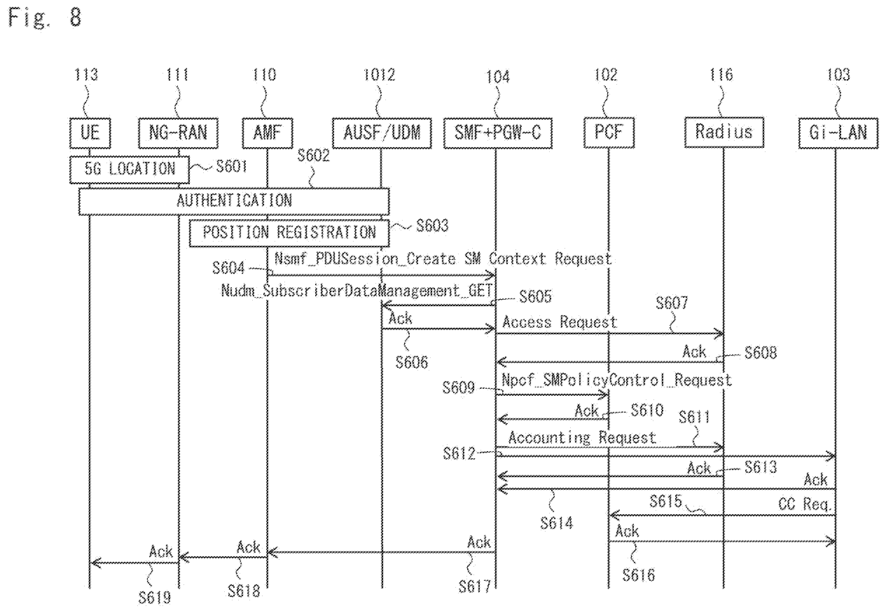

Next, with reference to FIG. 3, an operation example when the UE 113 located in a 5G area is attached in the wireless communication system according to the related art will be explained. Note that, in FIG. 3, an AUSF (Authentication Server Function)/UDM 1012 corresponds to a set of the part of an UDM in the HSS+UDM 101 in FIG. 1 and an AUSF not illustrated in FIG. 1. In addition, a Radius 116 is not illustrated in FIG. 1 (same in FIG. 5 and FIG. 8 to be explained below).

As illustrated in FIG. 3, the UE 113 is located in the 5G area, that is the area of the NG-RAN 111 (step S201). In this case, the AMF 110 authenticates the UE 113 using authentication information registered in the AUSF/UDM 1012 (step S202), and registers position information of the UE 113 in the AUSF/UDM 1012 (step S203).

Next, the AMF 110 transmits an Nsmf_PDUSession_Create SM Context Request message to the SMF+PGW-C 104 (step S204), the SMF+PGW-C 104 transmits an Nudm_SubscriberDataManagement_GET message to the AUSF/UDM 1012 (step S205), and the AUSF/UDM 1012 transmits the Ack message to the SMF+PGW-C 104 (step S206).

Then, the SMF+PGW-C 104 transmits an Access Request message to the Radius 116 (step S207), and the Radius 116 transmits the Ack message to the SMF+PGW-C 104 (step S208).

Next, the SMF+PGW-C 104 transmits the Npcf_SMPolicyControl_Request message to the PCF 102 (step S209), and the PCF 102 transmits the Ack message to the SMF+PGW-C 104 (step S210).

Then, the SMF+PGW-C 104 transmits an Accounting Request message to the Radius 116 and the Gi-LAN apparatus 103 (steps S211 and S212), and the Radius 116 and the Gi-LAN apparatus 103 transmit the Ack message to the SMF+PGW-C 104 (steps S213 and S214).

Next, the Gi-LAN apparatus 103 should transmit the Credit Control Request message which is the Diameter protocol compatible message to the PCF 102.

However, the Diameter protocol is not defined as the standard. Therefore, the Gi-LAN apparatus 103 could not be connected with the PCF 102 and could not transmit the Credit Control Request message to the PCF 102 (step S215). Note that, in this case, the Ack message is transmitted from the SMF+PGW-C 104 to the UE 113 via the AMF 110 and the NG-RAN 111 (steps S216-S218).

As a result, in the wireless communication system according to the related art, even when the UE 113 was located in the 5G area, there was a problem that a 5G service policy could not be applied from the Gi-LAN apparatus 103 to the UE 113.

As above, in the wireless communication system according to the related art, there were the problem that the 4G service policy from the PCRF 105 could not be applied to the UE 112 located in the 4G area and the problem that the 5G service policy from the Gi-LAN apparatus 103 could not be applied to the UE 113 located in the 5G area.

Next, the operation of the wireless communication system according to the present first example embodiment will be explained below.

First, with reference to FIG. 4, an operation example when the UE 112 located in the 4G area is attached in the wireless communication system according to the present first example embodiment will be explained.

As illustrated in FIG. 4, first, the operation of steps S301-S305 similar to steps S101-S105 in FIG. 2 is performed.

Then, the SMF+PGW-C 104 transmits the Npcf_SMPolicyControl_Request message which is the SBI protocol compatible message to the converter 114 (step S306).

Next, the converter 114 converts the Npcf_SMPolicyControl_Request message received from the SMF+PGW-C 104 to the Credit Control Request message which is the Diameter protocol compatible message, and transmits the Credit Control Request message to the PCRF 105 (step S307).

Then, the PCRF 105 transmits the Ack message which is the Diameter protocol compatible message to the converter 114 (step S308).

Next, the converter 114 converts the Ack message received from the PCRF 105 to the Ack message which is the SBI protocol compatible message, and transmits the Ack message to the SMF+PGW-C 104 (step S309).

Thereafter, the Ack message is transmitted from the SMF+PGW-C 104 to the UE 112 via the SGW 107, the MME 108 and the E-UTRAN 109 (steps S310-S313).

In such a manner, in the wireless communication system according to the present first example embodiment, since the converter 114 which is the SBI-Diameter conversion apparatus is provided, the SMF+PGW-C 104 can be connected with the PCRF 105 and transmit the Credit Control Request message to the PCRF 105.

As a result, in the wireless communication system according to the present first example embodiment, the 4G service policy from the PCRF 105 can be applied to the UE 112 located in the 4G area.

Next, with reference to FIG. 5, an operation example when the UE 113 located in the 5G area is attached in the wireless communication system according to the present first example embodiment will be explained.

As illustrated in FIG. 5, first, the operation of steps S401-S414 similar to steps S201-S214 in FIG. 3 is performed.

Then, the Gi-LAN apparatus 103 transmits the Credit Control Request message which is the Diameter protocol compatible message to the converter 115 (step S415).

Next, the converter 115 converts the Credit Control Request message received from the Gi-LAN apparatus 103 to the Npcf_SMPolicyControl_Request message which is the SBI protocol compatible message, and transmits the Npcf_SMPolicyControl_Request message to the PCF 102 (step S416).

Then, the PCF 102 transmits the Ack message which is the SBI protocol compatible message to the converter 115 (step S417).

Next, the converter 115 converts the Ack message received from the PCF 102 to the Ack message which is the Diameter protocol compatible message, and transmits the Ack message to the Gi-LAN apparatus 103 (step S418).

Thereafter, the Ack message is transmitted from the SMF+PGW-C 104 to the UE 113 via the AMF 110 and the NG-RAN 111 (steps S419-S421).

In such a manner, in the wireless communication system according to the present first example embodiment, since the converter 115 which is the SBI-Diameter conversion apparatus is provided, the Gi-LAN apparatus 103 can be connected with the PCF 102 and transmit the Credit Control Request message to the PCF 102.

As a result, in the wireless communication system according to the present first example embodiment, the 5G service policy from the Gi-LAN apparatus 103 can be applied to the UE 113 located in the 5G area.

As described above, in the wireless communication system according to the present first example embodiment, the converters 114 and 115 which are the SBI-Diameter conversion apparatuses are provided. Thus, the SMF+PGW-C 104 can be connected with the PCRF 105 and transmit the Credit Control Request message to the PCRF 105. In addition, the Gi-LAN apparatus 103 can be connected with the PCF 102 and transmit the Credit Control Request message to the PCF 102.

As a result, the 4G service policy from the PCRF 105 can be applied to the UE 112 located in the 4G area, and the 5G service policy from the Gi-LAN apparatus 103 can be applied to the UE 113 located in the 5G area.

### Second Example Embodiment

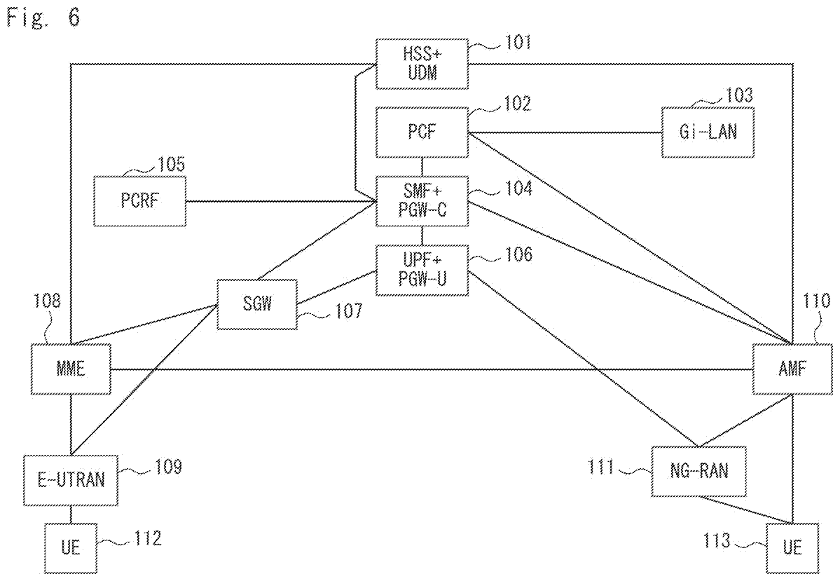

Next, with reference to FIG. 6, an overall configuration example of a wireless communication system according to the present second example embodiment will be explained.

As illustrated in FIG. 6, the wireless communication system according to the present second example embodiment is characterized by the point that the SMF+PGW-C104 combo/PCF102 is compatible with the Diameter protocol. That is, in the present second example embodiment, the network apparatus according to the present disclosure is the SMF+PGW-C104 combo/PCF102.

The SMF+PGW-C104 combo/PCF102 has the function of converting a Diameter protocol compatible message to an SBI protocol compatible message, and the function of converting an SBI protocol compatible message to a Diameter protocol compatible message.

In the wireless communication system according to the present second example embodiment, the SMF+PGW-C104 combo/PCF102 is compatible with the Diameter protocol. Therefore, an overall configuration of the wireless communication system according to the present second example embodiment is different at the point that the converters 114 and 115 are removed, compared to the first example embodiment described above.

Here, the SMF+PGW-C104 combo/PCF102 is connected to the SGW 107, the PCRF 105, and the Gi-LAN apparatus 103 or the like.

When the Create Session Request message which is the SBI protocol compatible message is received from the SGW 107, the SMF+PGW-C104 combo/PCF102 converts the Create Session Request message to the Credit Control Request message which is the Diameter protocol compatible message. Then, the SMF+PGW-C104 combo/PCF102 transmits the Credit Control Request message to the PCRF 105.

In addition, when the Ack message which is the Diameter protocol compatible message is received from the PCRF 105, the SMF+PGW-C 104 combo/PCF102 converts the Ack message to the Ack message which is the SBI protocol compatible message. Then, the SMF+PGW-C104 combo/PCF102 transmits the Ack message to the SGW 107.

Further, when the Credit Control Request message which is the Diameter protocol compatible message is received from the Gi-LAN apparatus 103, the SMF+PGW-C104 combo/PCF102 converts the Credit Control Request message to the SBI protocol compatible message. In addition, the SMF+PGW-C104 combo/PCF102 transmits the Ack message which is the Diameter protocol compatible message to the Gi-LAN apparatus 103.

Next, the operation of the wireless communication system according to the present second example embodiment will be explained below.

Note that, since the operation of the wireless communication system in which the SMF+PGW-C104 combo/PCF102 is not compatible with the Diameter protocol, according to the related art of the present second example embodiment, is similar to the operation explained in FIG. 2 and FIG. 3, the explanation is omitted.

First, with reference to FIG. 7, an operation example when the UE 112 located in the 4G area is attached in the wireless communication system according to the present second example embodiment will be explained.

As illustrated in FIG. 7, first, the operation of steps S501-S505 similar to steps S101-S105 in FIG. 2 is performed.

Next, the SMF+PGW-C 104 converts the Create Session Request message which is the SBI protocol compatible message received from the SGW 107 to the Credit Control Request message which is the Diameter protocol compatible message, and transmits the Credit Control Request message to the PCRF 105 (step S506).

Next, the PCRF 105 transmits the Ack message which is the Diameter protocol compatible message to the converter 114 (step S507).

Then, the SMF+PGW-C 104 converts the Ack message received from the PCRF 105 to the Ack message which is the SBI protocol compatible message, and transmits the Ack message to the SGW 107 (step S508).

Thereafter, the Ack message is transmitted from the SGW 107 to the UE 112 via the MME 108 and the E-UTRAN 109 (steps S509-S511).

In such a manner, in the wireless communication system according to the present second example embodiment, since the SMF+PGW-C104 combo/PCF102 is compatible with the Diameter protocol, the SMF+PGW-C 104 can be connected with the PCRF 105 and transmit the Credit Control Request message to the PCRF 105.

As a result, in the wireless communication system according to the present second example embodiment, the 4G service policy from the PCRF 105 can be applied to the UE 112 located in the 4G area.

Next, with reference to FIG. 8, an operation example when the UE 113 located in the 5G area is attached in the wireless communication system according to the present second example embodiment will be explained.

As illustrated in FIG. 8, first, the operation of steps S601-S614 similar to steps S201-S214 in FIG. 3 is performed.

Next, the Gi-LAN apparatus 103 transmits the Credit Control Request message which is the Diameter protocol compatible message to the PCF 102 (step S615).

Next, the PCF 102 converts the Credit Control Request message received from the Gi-LAN apparatus 103 to the SBI protocol compatible message. Then, the PCF 102 transmits the Ack message which is the Diameter protocol compatible message to the Gi-LAN apparatus 103 (step S616).

Thereafter, the Ack message is transmitted from the SMF+PGW-C 104 to the UE 113 via the AMF 110 and the NG-RAN 111 (steps S617-S619).

In such a manner, in the wireless communication system according to the present second example embodiment, since the SMF+PGW-C104 combo/PCF102 is compatible with the Diameter protocol, the Gi-LAN apparatus 103 can be connected with the PCF 102 and transmit the Credit Control Request message to the PCF 102.

As a result, in the wireless communication system according to the present second example embodiment, the 5G service policy from the Gi-LAN apparatus 103 can be applied to the UE 113 located in the 5G area.

As described above, in the wireless communication system according to the present second example embodiment, the SMF+PGW-C104 combo/PCF102 is compatible with the Diameter protocol. Thus, the SMF+PGW-C 104 can be connected with the PCRF 105 and transmit the Credit Control Request message to the PCRF 105. In addition, the Gi-LAN apparatus 103 can be connected with the PCF 102 and transmit the Credit Control Request message to the PCF 102.

As a result, the 4G service policy from the PCRF 105 can be applied to the UE 112 located in the 4G area, and also the 5G service policy from the Gi-LAN apparatus 103 can be applied to the UE 113 located in the 5G area.

<Hardware Configuration of Network Apparatus according to Example Embodiment>

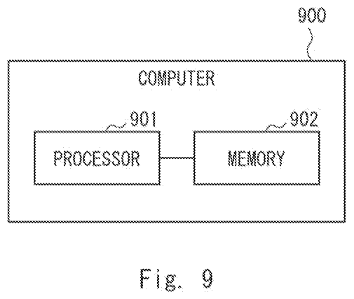

Next, with reference to FIG. 9, a hardware configuration example of a computer 900 which realizes the network apparatus (converters 114 and 115) according to the first example embodiment described above and the network apparatus (SMF+PGW-C104 combo/PCF102) according to the second example embodiment described above will be explained. The computer 900 illustrated in FIG. 9 includes a processor 901 and a memory 902. The processor 901 and the memory 902 are coupled to each other.

The processor 901 may be a microprocessor, an MPU (Micro Processing Unit) or a CPU (Central Processing Unit), for example. The processor 901 may include a plurality of processors.

The memory 902 is configured by a combination of a volatile memory and a nonvolatile memory. The memory 902 may include a storage arranged away from the processor 901. In this case, the processor 901 may access the memory 902 via a non-illustrated I (Input)/O (Output) interface.

The memory 902 may store a software module (computer program) including an instruction group and data for performing processing by the network apparatus explained in the first and second example embodiments described above.

In addition, in some implementations, the processor 901 may be configured to perform the processing of the network apparatus explained in the first and second example embodiments described above by reading and executing the software module from the memory 902.

Further, the program described above can be stored and supplied to the computer using a non-transitory computer-readable medium of various types. The non-transitory computer-readable medium includes a tangible storage medium of various types. Examples of the non-transitory computer-readable medium include a magnetic recording medium (for example, a flexible disk, a magnetic tape and a hard disk drive), a magneto-optical recording medium (for example, a magneto-optical disk), a CD-ROM (Compact Disc-ROM), a CD-R (CD-Recordable), a CD-R/W (CD-ReWritable), and a semiconductor memory (for example, a mask ROM, a PROM (Programmable ROM), an EPROM (Erasable PROM), a flash ROM and a RAM). In addition, the program may be supplied to the computer by a transitory computer-readable medium of various types.

Examples of the transitory computer-readable medium include an electric signal, an optical signal and an electromagnetic wave. The transitory computer-readable medium can supply the program to the computer via a cable communication channel such as an electric cable and an optical fiber or a wireless communication channel.

The present disclosure has been explained with reference to the example embodiments above, however, the present disclosure is not limited to the example embodiments described above. The configuration and details of the present disclosure can be modified in various manners which can be understood by those skilled in the art within the scope of the present disclosure.

Further, a part or all of the example embodiments described above may be described as, but are not limited to, the following supplementary notes.

(Supplementary note 1)

A network apparatus comprising:
a memory; and
at least one processor coupled to the memory,
wherein the at least one processor includes
a function of converting a Diameter protocol compatible message to an SBI protocol compatible message, and a function of converting the SBI protocol compatible message to the Diameter protocol compatible message.

(Supplementary note 2)

The network apparatus according to Supplementary note 1, the network apparatus
being a converter, and
being connected to an SMF (Session Management Function)+PGW-C (Packet data network Gateway-Control plane) combo/PCF (Policy Control Function) for which an SMF+PGW-C and a PCF are combined, and a PCRF

### (Policy and Charging Rule Function).

(Supplementary note 3)

The network apparatus according to Supplementary note 2, wherein, when an Npcf_SMPolicyControl_Request message which is the SBI protocol compatible message is received from the SMF+PGW-C combo/PCF, the at least one processor converts the Npcf_SMPolicyControl_Request message to a Credit Control Request message which is the Diameter protocol compatible message, and transmits the Credit Control Request message to the PCRF.

(Supplementary note 4)

The network apparatus according to Supplementary note 3, wherein, when an Ack (Acknowledgement) message which is the Diameter protocol compatible message is received from the PCRF, the at least one processor converts the Ack message to an Ack message which is the SBI protocol compatible message, and transmits the Ack message to the SMF+PGW-C combo/PCF.

(Supplementary note 5)

The network apparatus according to Supplementary note 1, the network apparatus
being a converter, and
being connected to an SMF F (Session Management Function)+PGW-C (Packet data network Gateway-Control plane) combo/PCF (Policy Control Function) for which an SM+PGW-C and a PCF are combined, and a Gi-LAN (Local Area Network) apparatus.

(Supplementary note 6)

The network apparatus according to Supplementary note 5, wherein, when a Credit Control Request message which is the Diameter protocol compatible message is received from the Gi-LAN apparatus, the at least one processor converts the Credit Control Request message to an Npcf_SMPolicyControl_Request message which is the SBI protocol compatible message, and transmits the Npcf_SMPolicyControl_Request message to the SMF+PGW-C combo/PCF.

(Supplementary note 7)

The network apparatus according to Supplementary note 6, wherein, when an Ack (Acknowledgement) message which is the SBI protocol compatible message is received from the SMF+PGW-C combo/PCF, the at least one processor converts the Ack message to an Ack message which is the Diameter protocol compatible message, and transmits the Ack message to the Gi-LAN apparatus.

(Supplementary note 8)

The network apparatus according to Supplementary note 1, the network apparatus
being an SMF (Session Management Function)+PGW-C(Packet data network Gateway-Control plane) combo/PCF (Policy Control Function) for which an SMF+PGW-C and a PCF are combined, and
being connected to an SGW (Serving Gateway) and a PCRF (Policy and Charging Rule Function).

(Supplementary note 9)

The network apparatus according to Supplementary note 8, wherein, when a Create Session Request message which is the SBI protocol compatible message is received from the SGW, the at least one processor converts the Create Session Request message to a Credit Control Request message which is the Diameter protocol compatible message, and transmits the Credit Control Request message to the PCRF.

(Supplementary note 10)

The network apparatus according to Supplementary note 9, wherein, when an Ack (Acknowledgement) message which is the Diameter protocol compatible message is received from the PCRF, the at least one processor converts the Ack message to an Ack message which is the SBI protocol compatible message, and transmits the Ack message to the SGW.

(Supplementary note 11)

The network apparatus according to any one of Supplementary notes 8 to 10, the network apparatus being further connected to a Gi-LAN (Local Area Network) apparatus.

(Supplementary note 12)

The network apparatus according to Supplementary note 11, wherein, when a Credit Control Request message which is the Diameter protocol compatible message is received from the Gi-LAN apparatus, the at least one processor converts the Credit Control Request message to the SBI protocol compatible message, and transmits an Ack (Acknowledgement) message which is the Diameter protocol compatible message to the Gi-LAN apparatus.

(Supplementary note 13)

A method executed by a network apparatus, the method comprising:
a step of converting a Diameter protocol compatible message to an SBI protocol compatible message; and
a step of converting the SBI protocol compatible message to the Diameter protocol compatible message.

(Supplementary note 14)

A non-transitory computer-readable medium storing a program for making a computer execute:
a procedure of converting a Diameter protocol compatible message to an SBI protocol compatible message; and
a procedure of converting the SBI protocol compatible message to the Diameter protocol compatible message.

### REFERENCE SIGNS LIST

101 HSS+UDM
1011 HSS
1012 AUSF/UDM
102 PCF
103 Gi-LAN APPARATUS
104 SMF+PGW-C
105 PCRF
106 UPF+PGW-U
107 SGW
108 MME
109 E-UTRAN
110 AMF
111 NG-RAN
112, 113 UE
114, 115 CONVERTER
116 Radius
900 COMPUTER
901 PROCESSOR
902 MEMORY

What is claimed is:

1. A network apparatus comprising:
a memory; and
at least one processor coupled to the memory,
wherein the at least one processor includes
a function of converting a Diameter protocol compatible message to an SBI (Service Based Interface) protocol compatible message, and a function of converting the SBI protocol compatible message to the Diameter protocol compatible message.

2. The network apparatus according to claim 1, the network apparatus
being a converter, and
being connected to an SMF (Session Management Function)+PGW-C(Packet data network Gateway-Control plane) combo/PCF (Policy Control Function) for which an SMF+PGW-C and a PCF are combined, and a PCRF (Policy and Charging Rule Function).

3. The network apparatus according to claim 2, wherein, when an Npcf_SMPolicyControl_Request message which is the SBI protocol compatible message is received from the SMF+PGW-C combo/PCF, the at least one processor converts the Npcf_SMPolicyControl_Request message to a Credit Control Request message which is the Diameter protocol compatible message, and transmits the Credit Control Request message to the PCRF.

4. The network apparatus according to claim 3, wherein, when an Ack (Acknowledgement) message which is the Diameter protocol compatible message is received from the PCRF, the at least one processor converts the Ack message to an Ack message which is the SBI protocol compatible message, and transmits the Ack message to the SMF+PGW-C combo/PCF.

5. The network apparatus according to claim 1, the network apparatus
being a converter, and
being connected to an SMF F (Session Management Function)+PGW-C(Packet data network Gateway-Control plane) combo/PCF (Policy Control Function) for which an SM+PGW-C and a PCF are combined, and a Gi-LAN (Local Area Network) apparatus.

6. The network apparatus according to claim 5, wherein, when a Credit Control Request message which is the Diameter protocol compatible message is received from the Gi-LAN apparatus, the at least one processor converts the Credit Control Request message to an Npcf_SMPolicyControl_Request message which is the SBI protocol compatible message, and transmits the Npcf_SMPolicyControl_Request message to the SMF+PGW-C combo/PCF.

7. The network apparatus according to claim 6, wherein, when an Ack (Acknowledgement) message which is the SBI protocol compatible message is received from the SMF+PGW-C combo/PCF, the at least one processor converts the Ack message to an Ack message which is the Diameter protocol compatible message, and transmits the Ack message to the Gi-LAN apparatus.

8. The network apparatus according to claim 1, the network apparatus
being an SMF (Session Management Function)+PGW-C(Packet data network Gateway-Control plane) combo/PCF (Policy Control Function) for which an SMF+PGW-C and a PCF are combined, and
being connected to an SGW (Serving Gateway) and a PCRF (Policy and Charging Rule Function).

9. The network apparatus according to claim 8, wherein, when a Create Session Request message which is the SBI protocol compatible message is received from the SGW, the at least one processor converts the Create Session Request message to a Credit Control Request message which is the Diameter protocol compatible message, and transmits the Credit Control Request message to the PCRF.

10. The network apparatus according to claim 9, wherein, when an Ack (Acknowledgement) message which is the Diameter protocol compatible message is received from the PCRF, the at least one processor converts the Ack message to an Ack message which is the SBI protocol compatible message, and transmits the Ack message to the SGW.

11. The network apparatus according to claim 8, the network apparatus being further connected to a Gi-LAN (Local Area Network) apparatus.

12. The network apparatus according to claim 11, wherein, when a Credit Control Request message which is the Diameter protocol compatible message is received from the Gi-LAN apparatus, the at least one processor converts the Credit Control Request message to the SBI protocol compatible message, and transmits an Ack (Acknowledgement) message which is the Diameter protocol compatible message to the Gi-LAN apparatus.

13. A method executed by a network apparatus, the method comprising:
a step of converting a Diameter protocol compatible message to an SBI (Service Based Interface) protocol compatible message; and
a step of converting the SBI protocol compatible message to the Diameter protocol compatible message.

14. A non-transitory computer-readable medium storing a program for making a computer execute:
a procedure of converting a Diameter protocol compatible message to an SBI (Service Based Interface) protocol compatible message; and
a procedure of converting the SBI protocol compatible message to the Diameter protocol compatible message.
